(19) United States
(12) Patent Application Publication
(10) Pub. No.: US 2022/0148112 A1
(43) Pub. Date: May 12, 2022

(54) Online Contract Negotiation System

(71) Applicant: Digipitch Corporation, Spicewood, TX (US)

(72) Inventors: Eric Wayne Key, Indianapolis, IN (US); Zoltan A. Papp, Spicewood, TX (US)

(21) Appl. No.: 17/438,910

(22) PCT Filed: Mar. 11, 2019
(86) PCT No.: PCT/US2019/021627

§ 371 Date: Sep. 13, 2021

(51) Int. Cl. G06Q 50/18; H04L 9/32

(52) U.S. Cl. CPC G06Q 50/188; H04L 2209/38; H04L 9/3239

(57) ABSTRACT

A system, method, and computer-readable medium are disclosed for improved online contract negotiations, such as in negotiating to sell a movie script or screenplay. A party initiates a transactional or negotiation phase with another party. Initial terms to the contract are negotiated, where several iterations are timestamped. Associated content with the contract is created in parallel, where versions of the contract are memorialized by a timestamp. The final version of the contract along with the associated content is encrypted, such as by a block chain.

### BACKGROUND OF THE INVENTION

### Field of the Invention

The present invention relates to information handling systems. More specifically, embodiments of the invention provide a system, method, and computer-readable medium for improved online contract negotiations.

### Description of the Related Art

In traditional contract negotiations, or in arranging to reach an agreement between parties, personal meetings take place. Numerous meetings may occur before an actual agreement is reached. Oftentimes, the parties may have confidential information that they want to share. Such confidential information may be critical for one party in deciding to reach an agreement. The other party may be skeptical in sharing the idea before the agreement is reached. Non-disclosure agreements (NDAs) may help; however, NDAs do not help in certain cases. For example, the NDA may include information that is already known by the party asking for such information. Already there is disagreement, before an agreement can be reached.

As an example, traditional negotiations in selling a film script by a screenwriter typically require an agent negotiating with producers. There is an old saying in Hollywood that “you can't sell a script without an agent and you can't get an agent without selling a script.” In most cases this is still true with the exception of a few cases of screenwriters who happen to be in the right place at the right time. Due to legal fears of plagiarism, etc., most producers will not accept unsolicited or unrepresented scripts directly from a screenwriter. Instead, producers rely on agents to provide the material and to make all the necessary arrangements.

In certain instances, if a screenwriter is not represented by an agent, the screenwriter may be required to sign a submission release when asked to submit a script or screenplay to a producer, studio, network, etc. A submission release is a written agreement in which the screenwriter relieves the recipient (e.g., producer, studio, network, etc.) of the screenplay from liability should the recipient use any of the content in the screenplay that is not protected by copyright, such as idea or the public domain material incorporated therein. The submission release may also relieve the recipient of the obligation to pay if the recipient independently creates similar material, or comes by the material from an independent source.

The submission release may also state that the recipient will pay fair market value if the recipient decides to use the screenplay, or any portion protected by copyright. The submission release can supersede any oral agreement that may have been made to the contrary with the recipient. As tedious as submission releases are, many producer, studio, network require submission releases to protect themselves from potential lawsuits. In addition, agents may also require a submission release as a condition to reading the screenplay.

### SUMMARY OF THE INVENTION

A system, method, and computer-readable medium are disclosed for improved online contract negotiations. A transactional or negotiation phase can be initiated by a party with another party. Initial terms to the contract can be initiated and negotiated, which can involve several iterations which are timestamped. Associated content with the contract can be created in parallel, where versions of the contract can be memorialized by a timestamp. The final version of the contract along with the associated content can be encrypted, such as by a block chain.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an online contract negotiation system;

FIG. 2 is a generalized flowchart for online contract negotiation; and

FIG. 3 is a computer system that implements the processes and techniques described herein.

### DETAILED DESCRIPTION

A system, method, and computer-readable medium are disclosed for online contract negotiations. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

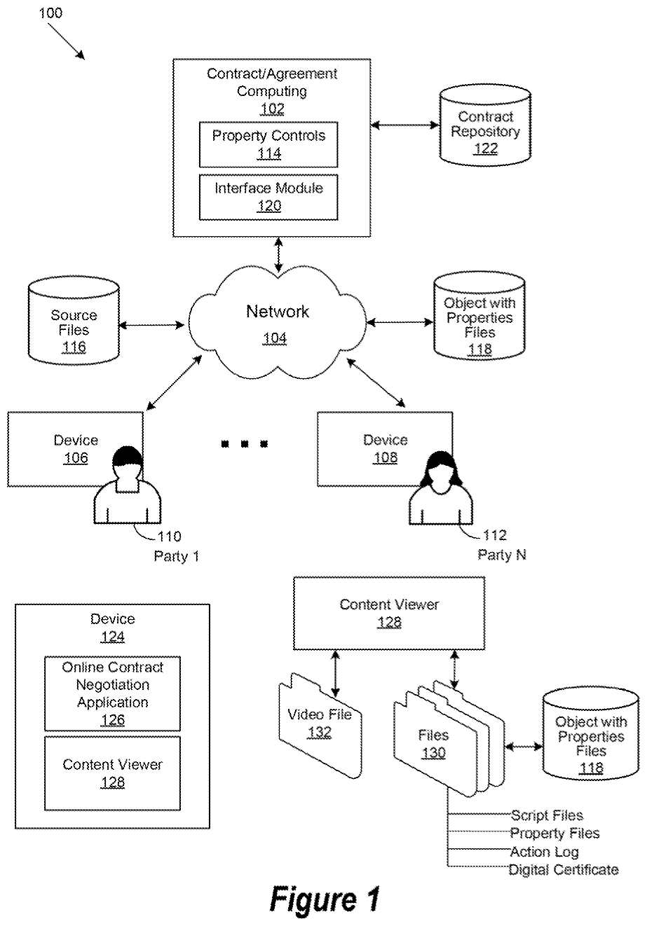

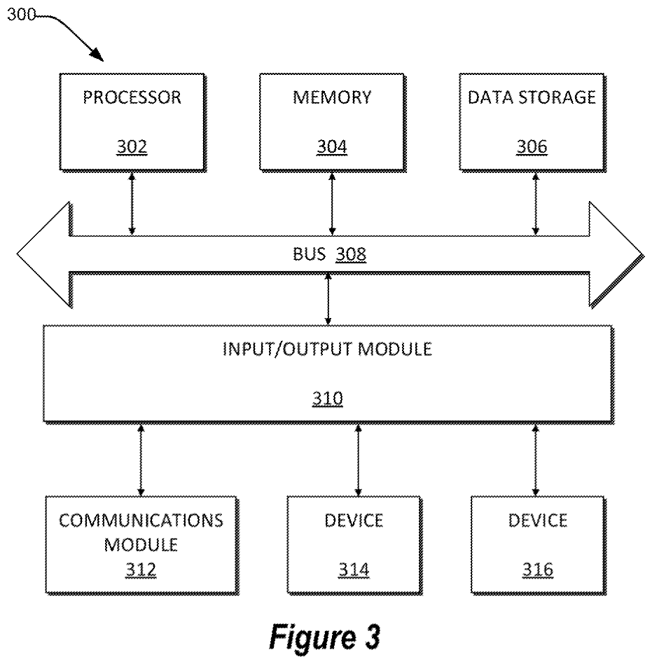

FIG. 1 is a generalized illustration of an online contract negotiation system. In certain embodiments, the online contract negotiation system 100 includes a centralized contract/agreement computing system 102. The contract/agreement computing system 102 can be considered an information handling system as discussed above, and implemented as one or more computer systems as further described below in reference to FIG. 3.

The contract/agreement computing system 102 connects with a network 104. The network 104 can include various wired and wireless networks, accessing the Internet and World Wide Web (www). Furthermore, network 104 can connect with various other devices, including information handling devices. In certain embodiments, network 104 connects the contract/agreement computing system 102 with multiple devices, as represented by device 106 to device 108. Device 106 to device 108 can be considered an information handling system as discussed above, and implemented as one or more computer systems as further described below in reference to FIG. 3.

As shown, device 106 is used by a party 1 110 and device is used by a party N 112. In certain implementations, party 1 110 negotiates with party N 112 to reach an agreement or contract with one another. For example, in the case of screenwriter selling a script or screenplay to a producer, studio, network, etc., party 1 110 can be a screenwriter and party N 112 can be a producer, studio, network, etc. In other examples, parties can include actors, athletes, musicians, antique sellers/buyers, music studios, etc. It is to be understood, that parties can include entities that are negotiating to contract for works, goods, products, services. The example of a screenwriter selling a script or screenplay to a producer is used as one example of such a negotiation to reach an agreement or contract, throughout this description.

In certain implementations, the contract/agreement computing system 102 includes a property controls module 114. The property controls module 114 can be configured to assign properties, tags, attributes, etc. to source or object files. In certain implementations, the property controls module is configured to add a timestamp to the source or object files. Implementation of a timestamp can memorialize the creation of the work in the source or object, and can assist in establishing a “copyright” or “blockright. This establishes a Proof of Work (PoW) or Proof of Stake (PoS). Such source or object files, includes content such a movie script (script), screenplay, book or other printed work, music recording, written lyrics, melodies, or other work, description of a good/service, etc. In certain implementations, multiple source or object files are processed by property controls module 114 as a part of an agreement or contract. Such source or object files can be received from multiple repositories, as represented by source files 116.

In certain implementations, source or object files that are processed by the property controls module are stored in one or more repositories, as represented by object with properties files 118. In certain implementations, the contract/agreement computing system 102 includes an interface module 116. The interface module 116 can be configured to search and parse processed source or object files from object with properties files 118. In particular, such parsed processed source or objects files can be associated with an agreement or contract that is negotiated by parties, such as party 1 110 and party N 112. The contract/agreement computing system 102 can be configured to a contract repository 122. The repository 122 includes agreements or contracts between parties, such as party 1 110 and party N 112. Such agreements or contracts are further described below.

Device 124 is an implementation of device 106 to device 108. In such an implementation, the device 124 includes an online contract negotiation application 126. The online contract negotiation application 126 allows users (i.e., parties) of device 124 to negotiate for agreements or contracts with other users or parties. In particular, online contract negotiation application 126 allows communication and interaction with the contract/agreement computing system 102.

In certain implementations, the device 124 includes a content viewer 128 can be configured read files 130. Files 130 can be received from object with properties files 118 and are associated with a particular contract or agreement from contract repository 122. In certain implementations, files 130 are configured as a set of files which may be linked that can include content files such as script files, property files, action logs, and a digital certificate. The content viewer 128 can be configured to read such files, and in certain implementations configured to gather statistics. In certain implementations, opening the bundled set of files can initiate a timestamp, logs and reports by the content viewer 128. The timestamp, logs and reports will be generated, saved and re-uploaded upon file closure. In certain implementations, the content viewer 128 can be configured to play an associated or linked content file to files 130, such as a video. For example, when negotiating as to a script or screenplay, a video link to a video file 132 may be available that includes a sales pitch or related scene(s) to the script or screenplay.

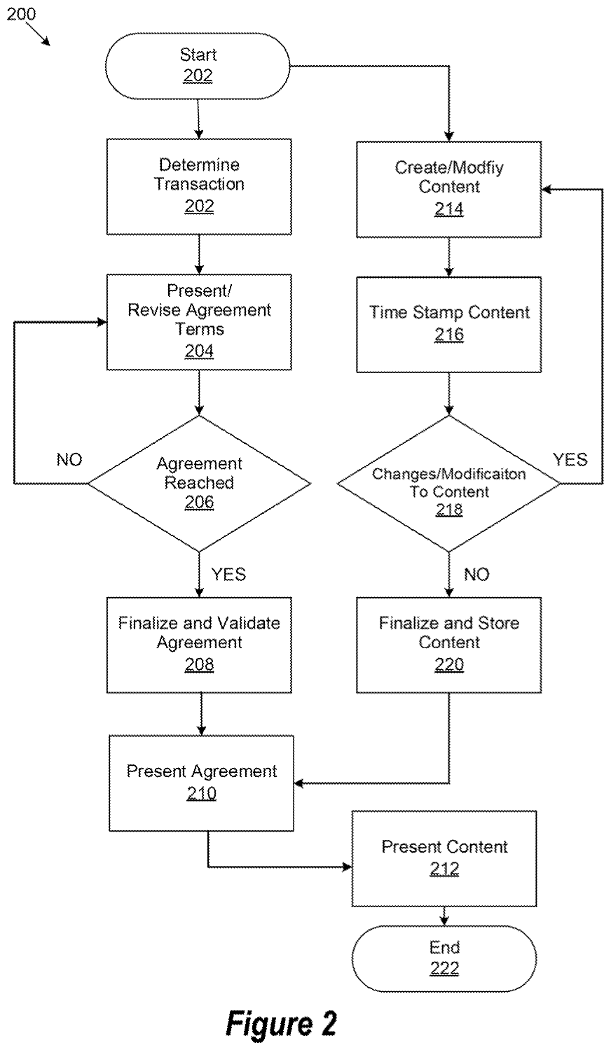

FIG. 2 is a generalized flowchart 200 for online contract negotiation. In various embodiments, the online contract negotiation system 100 and contract/agreement computing system 102 are implemented. In particular, the process can be performed when negotiating a contract or agreement between parties, such as party 1 110 to party N 112. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 202 the process 200 starts. In certain implementations parallel steps are performed in reaching a contract or agreement. At block 202, determining a transaction is performed, starting a transactional phase between parties. The transaction can be selling a script or screenplay. At step 204, agreement terms are presented. Such terms to the agreement or contract can be an initial set of terms or revised terms after one or more iterations between the parties. If an agreement is not reached, following the “NO” branch of block 206, step 204 is performed, revising the previous terms. If an agreement is reached, following the “YES” branch of block 206, at step 208, the contract or agreement is finalized and validated. In certain implementations, finalizing and validating the agreement or contract includes using an encryption method, such as blockchain. The encryption method can include a timestamp. In addition, finalizing and validating the agreement or contract can include a digital certificate or receipt. In certain implementations, a ledger is used as part of finalizing and validating the agreement or contracts. At block 210, presenting the finalized contract or agreement is performed. The finalized contract is presented to the respective negotiating parties. At block 212, presenting associated content is performed.

In parallel with reaching a contract or agreement, steps can be performed in creating content associated with such a contract or agreement. In particular, a final version and various intermediate versions of the content can be created and memorialized. At block 214, creation or modification of content is performed. A party, such as grantor of a work, e.g., script or screenplay, submits content such as contents from a source files 116. At step 216, timestamp of the particular version of the content is performed. The particular version of the content receives a timestamp to memorialize the submission. If changes or modifications to the content are made, then following the “YES” branch of block 218, step 214 is performed. If no changes nor modifications to the content are made, then following the “NO” branch of block 218, at step 220, the content is finalized and stored (resubmitted). A timestamp can be added to the final version of the content. At step 210, the agreement is presented, and at step 212 to content is presented to the parties. The process ends at block 222.

To further illustrate negotiating and reaching an agreement or contract between parties using the described systems, the example of a screenwriter selling a script or screenplay to a producer is described. In an example scenario, a producer may browse a website that supports a marketplace for scripts and screenplays. A particular entry or log line and synopsis interests the producer. The entry relates to a particular script or screenplay, and the producer would like to read the entire script or screenplay. The screenwriter of the script or screenplay has no representation or agent.

Through the online contract negotiation system 100, the screenwriter and producer negotiate and create a contract. For example, the producer can initiate an agreement or contract with the screenwriter. The contract can be created using standard terms with release form liability. In certain implementations, the online contract negotiation system 100 can provide a hard copy of the script or screenplay to the producer. For example, the contract can include language as to terms releasing liability, that if the screenwriter to, the producer will then read the screenplay at no obligation.

In certain implementations, upon initiation of the contract, request for the contract is sent to the contract/agreement computing system 102 where the contract is personalized and forwarded to the screenwriter and producer. As described above, several iterations can be performed before the contract is finalized. The finalized contract is memorialized and can be encrypted, such as using blockchain. The blockchain encryption can include providing a timestamp and hash to the contract.

FIG. 3 is a block diagram illustrating an exemplary computer system 300 that may be utilized in the implementations as described herein. In certain aspects, the computer system 300 may be implemented using hardware or a combination of software and hardware, either in a dedicated server, or integrated into another entity, or distributed across multiple entities.

Computer system 300 includes a bus 308 or other communication mechanism for communicating information, and a processor 302 coupled with bus 308 for processing information. By way of example, the computer system 300 may be implemented with one or more processors 302.

Computer system 300 can include, in addition to hardware, code that creates an execution environment for the computer program in question, e.g., code that constitutes processor firmware, a protocol stack, a database management system, an operating system, or a combination of one or more of them stored in an included memory 304, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 308 for storing information and instructions to be executed by processor 302. The processor 302 and the memory 304 can be supplemented by, or incorporated in, logic circuitry.

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more location without deviating from the scope of the disclosed subject matter. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The elements described and depicted herein, including in flow charts and block diagrams throughout the figures, imply logical boundaries between the elements. However, according to software or hardware engineering practices, the depicted elements and the functions thereof may be implemented on machines through non-transitory computer executable media having a processor capable of executing program instructions stored thereon as a monolithic software structure, as standalone software modules, or as modules that employ external routines, code, services, and so forth, or any combination of these, and all such implementations may be within the scope of the present disclosure.

Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various techniques identified and described above may be varied, and that the order of techniques may be adapted to particular applications of the techniques disclosed herein. All such variations and modifications are intended to fall within the scope of this disclosure. As such, the depiction and/or description of an order for various techniques should not be understood to require a particular order of execution for those techniques, unless required by a particular application, or explicitly stated or otherwise clear from the context.

The methods and/or processes described above, and techniques thereof, may be realized in hardware, or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The instructions may be stored in the memory 304 and implemented in one or more computer program products, i.e., one or more modules of computer program instructions encoded on a computer readable medium for execution by, or to control the operation of, the service 100, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python).

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 300 further includes a data storage device 306 such as a magnetic disk or optical disk, coupled to bus 308 for storing information and instructions. Computer system 300 may be coupled via an input/output module 310 to various devices. The input/output module 310 can be any input/output module. Example input/output modules 310 include data ports such as USB ports. The input/output module 310 is configured to connect to a communications module 312. Example communications modules 312 include networking interface cards, such as Ethernet cards and modems. In certain aspects, the input/output module 310 is configured to connect to a plurality of devices, such as an input device 314 and/or an output device 316. Example input devices 314 include a keyboard and a pointing device, e.g., a mouse or a trackball, by which a user can provide input to the computer system 300. Other kinds of input devices 314 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 316 include display devices, such as am LED (light emitting diode) or LCD (liquid crystal display) monitor, for displaying information to the user.

According to one aspect of the present disclosure, the system for associating a file type with an application as shown in FIGS. 1-2, can be implemented using a computer system 300 in response to processor 302 executing one or more sequences of one or more instructions contained in memory 304. Such instructions may be read into memory 304 from another machine-readable medium, such as data storage device 306. Execution of the sequences of instructions contained in main memory 304 causes processor 302 to perform the processes described herein. One or more processors in a multi-processing arrangement may also be employed to execute the sequences of instructions contained in memory 304. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a personal area network (PAN), a local area network (LAN), a campus area network (CAN), a metropolitan area network (MAN), a wide area network (WAN), a broadband network (BBN), the Internet, and the like. Further, the communication networks can include, but are not limited to, for example, any one or more of the following network topologies, including a bus network, a star network, a ring network, a mesh network, a star-bus network, tree or hierarchical network, or the like. The communications modules can be, for example, modems or Ethernet cards.

As discussed above, computing system 300 can include clients and servers. A client and server are generally remote from each other and typically interact through a communication network. The relationship of client and server arises by virtue of computer programs running on the respective computers and having a client-server relationship to each other. Computer system 300 can be, for example, and without limitation, an enterprise server or group of servers, one or more desktop computers, one or more laptop computers, etc. Computer system 300 can also be embedded in another device, for example, and without limitation, a mobile telephone, a tablet, a mobile audio player, a Global Positioning System (GPS) receiver, a video game console, and/or a television set top box.

The term “machine-readable storage medium” or “computer readable medium” as used herein refers to any medium or media that participates in providing instructions to processor 302 for execution. Such a medium may take many forms, including, but not limited to, non-volatile media, volatile media, and transmission media. Non-volatile media include, for example, optical or magnetic disks, such as data storage device 306. Volatile media include dynamic memory, such as memory 304.

Transmission media include coaxial cables, copper wire, and fiber optics, including the wires that comprise bus 308. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

While this specification contains many specifics, these should not be construed as limitations on the scope of what may be claimed, but rather as descriptions of particular implementations of the subject matter. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

In the claims appended herein, the inventors invoke 35 U.S.C. § 112, paragraph 6 only when the words “means for” or “steps for” are used in the claim. If such words are not used in a claim, then the inventors do not intend for the claim to be construed to cover the corresponding structure, material, or acts described herein (and equivalents thereof) in accordance with 35 U.S.C. § 112, paragraph 6.

What is claimed is:

1. A computer-implementable method for contract negotiation comprising:
starting a transactional phase for a contract between two or more parties;
determining if terms to the contract between the two or more parties are acceptable;
associating content that is part of a finalized contract between the two or more parties;
providing the finalized contract with content associated with the finalized contract in a time stamped file readable by devices implemented by the two or more parties.

2. The method of claim 1, wherein the starting of the transactional phase includes determining type of contract to be negotiated.

3. The method of claim 1, wherein the determining if terms to the contract between the two parties comprises iterative versions of the terms which are timestamped.

4. The method of claim 1, wherein the content includes movie scripts, scripts, screenplays, books or other printed works, music recordings, written lyrics, and melodies.

5. The method of claim 1, wherein versions of the content are iteratively created until a final version of the content is created, wherein each version of the content is timestamped.

6. The method of claim 5, wherein the versions of the content are created in parallel with creating the finalized contract.

7. The method of claim 1 further comprising encrypting the finalized contract and associated content.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for improved management of unattended user queries and comprising instructions executable by the processor and configured for:
starting a transactional phase for a contract between two or more parties;
determining if terms to the contract between the two or more parties are acceptable;
associating content that is part of a finalized contract between the two or more parties;
providing the finalized contract with content associated with the finalized contract in a time stamped file readable by devices implemented by the two or more parties.

9. The system of claim 8, wherein the transactional phase is initiated from one party.

10. The system of claim 8, wherein the determining if terms to the contract between the two parties comprises iterative versions of the terms which are timestamped.

11. The system of claim 8, wherein versions of the content are iteratively created until a final version of the content is created, wherein each version of the content is timestamped.

12. The system of claim 11, wherein the content wherein the content includes movie scripts, scripts, screenplays, books or other printed works, music recordings, written lyrics, and melodies.

13. The system of claim 8 further comprising encrypting the finalized contract with content associated with the finalized contract using a blockchain.

14. A non-transitory, computer-readable storage medium embodying computer program code, the computer program code comprising computer executable instructions configured for:
starting a transactional phase for a contract between two or more parties;
determining if terms to the contract between the two or more parties are acceptable;
associating content that is part of a finalized contract between the two or more parties;
providing the finalized contract with content associated with the finalized contract in a time stamped file readable by devices implemented by the two or more parties.

15. The non-transitory, computer-readable storage medium of claim 14, wherein the starting of the transactional phase includes determining type of contract to be negotiated.

16. The non-transitory, computer-readable storage medium of claim 14, wherein the determining if terms to the contract between the two or more parties comprises iterative versions of the terms which are timestamped.

17. The non-transitory, computer-readable storage medium of claim 14, wherein the content includes movie scripts, scripts, screenplays, books or other printed work, music recordings, written lyrics, and melodies.

18. The non-transitory, computer-readable storage medium of claim 14, wherein versions of the content are iteratively created until a final version of the content is created, wherein each version of the content is timestamped.

19. The non-transitory, computer-readable storage medium of claim 18, wherein the versions of the content are created in parallel with creating the finalized contract.

20. The non-transitory, computer-readable storage medium of claim 15 further comprising encrypting the finalized contract and associated content using a blockchain.
